(19) United States
(12) Patent Application Publication
(10) Pub. No.: US 2021/0031342 A1
(43) Pub. Date: Feb. 4, 2021

(54) ROTARY IMPACT TOOL

(71) Applicant: MAKITA CORPORATION, Anjo-shi (JP)

(72) Inventor: Koji TAKAHAGI, Anjo-shi (JP)

(73) Assignee: MAKITA CORPORATION, Anjo-shi (JP)

(21) Appl. No.: 16/915,068

(22) Filed: Jun. 29, 2020

(30) Foreign Application Priority Data
Aug. 1, 2019 (JP) 2019-142412

(51) Int. Cl. B25B 23/145; B25B 21/02; B25B 21/00

(52) U.S. Cl. CPC B25B 23/1453; B25B 21/008; B25B 21/023

(57) ABSTRACT

Torque produced in an oil unit is leveled irrespective of the temperature variation to maintain intended operation efficiency. An impact driver includes a brushless motor, and an oil unit rotatable by the brushless motor. The oil unit includes a case including a projection inside, a spindle protruding from the case, a coil spring held at the spindle in the case, and a blade held at the spindle in the case and urged outward in a radial direction of the case by the coil spring. The blade comes in contact with the projection in a rotation direction of the case.

### CROSS-REFERENCE TO RELATED APPLICATIONS

This application claims the benefit of priority to Japanese Patent Application No. 2019-142412, filed on Aug. 1, 2019, the entire contents of which are hereby incorporated by reference.

### BACKGROUND

### 1. Technical Field

The present invention relates to a rotary impact tool such as an impact driver including an oil unit.

### 2. Description of the Background

A rotary impact tool with an oil unit, such as an impact driver, transmits the rotation of a motor to a spindle via the oil unit as an intermittent impact torque (impact). An oil unit is described in, for example, Japanese Unexamined Patent Application Publication No. 2019-48383. A known oil unit includes a case containing oil, through which the rotation of the motor is transmitted, and a spindle having a rear portion placed in the case in a rotatable manner. The spindle receives, in the rear portion, a cam that rotates integrally with the case at the center of the case. The spindle accommodates a pair of balls and a pair of blades each in a radially movable manner in the rear portion and outside the cam.

In the known oil unit, the cam integral with the case rotates as the case rotates, pushing the blades radially outward via the balls in the rear portion. When the cam seals the rear portion in the case at a predetermined rotational position, the blades pushed out are retained there under the oil pressure. The blades hitting projections in the case produce an impact torque (impact). Subsequently, when the cam rotates together with the case, the oil in the rear portion flows out to reduce the oil pressure. This allows the blades to retract into the rear portion and move relatively over the projections. The repeated motions of the blades being pushed out, hitting the projections, and retracting produce impacts intermittently.

### BRIEF SUMMARY

The known oil unit may heat up when the oil in the oil unit is agitated during use or due to frictional heat between the components. As the temperature changes, the viscosity of the oil changes. More specifically, the viscosity is higher at a lower temperature, whereas the viscosity is lower at a higher temperature. With the oil at a lower temperature, the blades retracting from the projections under an impact torque receive a larger resistance, thus increasing the contact duration with the projections and producing a larger torque. With the oil at a higher temperature after a continuous operation such as screwing, the blades retracting from the projections under an impact torque receive a smaller resistance, decreasing the contact duration with the projections and producing a smaller torque. This extends the time taken to fasten each screw and lowers the operation efficiency.

One or more aspects of the present invention are directed to a rotary impact tool that levels torque produced in an oil unit irrespective of the temperature variation to maintain intended operation efficiency.

A first aspect of the present invention provides a rotary impact tool, including:

a motor; and

an oil unit configured to rotate by the motor, the oil unit including
a case including a projection inside,
an output shaft protruding from the case,
an elastic member held at the output shaft in the case, and
a torque transmission member held at the output shaft in the case and urged outward in a radial direction of the case by the elastic member, the torque transmission member being configured to come in contact with the projection in a rotation direction of the case.

A second aspect of the present invention provides a rotary impact tool, including:

a motor; and

an oil unit configured to rotate by the motor, the oil unit including
a case including a projection inside,
an output shaft protruding from the case,
at least one torque transmission member held at the output shaft in the case,
a first pushing member held at the output shaft in the case and configured to move the torque transmission member outward in a radial direction of the case as the case rotates, and
a second pushing member held at the output shaft in the case and configured to move the torque transmission member moved by the first pushing member outward in the radial direction of the case as the case rotates.

The rotary impact tool according to the above aspects levels torque produced in the oil unit irrespective of the temperature variation to maintain intended operation efficiency.

### BRIEF DESCRIPTION OF DRAWINGS

FIG. 1 is a side view of an impact driver according to a first embodiment.

FIG. 2 is a longitudinal central sectional view of the impact driver according to the first embodiment.

FIG. 3 is an enlarged cross-sectional view taken along line A-A in FIG. 1.

FIG. 4A is a longitudinal central sectional view of an oil unit according to the first embodiment, and FIG. 4B is a cross-sectional view taken along line B-B.

FIG. 5A is a cross-sectional view taken along line C-C in FIG. 4A with blades pushed out, and FIG. 5B is a cross-sectional view taken along line D-D with the blades pushed out.

FIG. 6A is a cross-sectional view of a cam in the oil unit according to the first embodiment with the blades at the start of being pushed out, and FIG. 6B is a cross-sectional view of a coil spring in the oil unit according to the first embodiment with the blades at the start of being pushed out.

FIG. 7 is a cross-sectional view of the cam in the oil unit according to the first embodiment immediately before striking (at lower temperatures).

FIG. 8A is a cross-sectional view of the cam in the oil unit according to the first embodiment immediately before striking (at higher temperatures), and FIG. 8B is a cross-sectional view of the coil spring in the oil unit according to the first embodiment immediately before striking (at higher temperatures).

FIG. 9A is a cross-sectional view of the cam in the oil unit according to the first embodiment after striking, and FIG. 9B is a cross-sectional view of the coil spring in the oil unit according to the first embodiment after striking.

FIGS. 10A to 10C are graphs each showing the relationship between the surface temperature of an oil unit included in a pushing structure and the efficiency ratio.

FIG. 11A is a longitudinal central sectional view of an oil unit according to a second embodiment, and FIG. 11B is a cross-sectional view taken along line E-E.

FIG. 12A is a cross-sectional view taken along line F-F in FIG. 11A, FIG. 12B is a cross-sectional view immediately before striking, and FIG. 12C is a cross-sectional view after striking.

### DETAILED DESCRIPTION

Embodiments of the present invention will now be described with reference to the drawings.

### First Embodiment

### Overview of Impact Driver

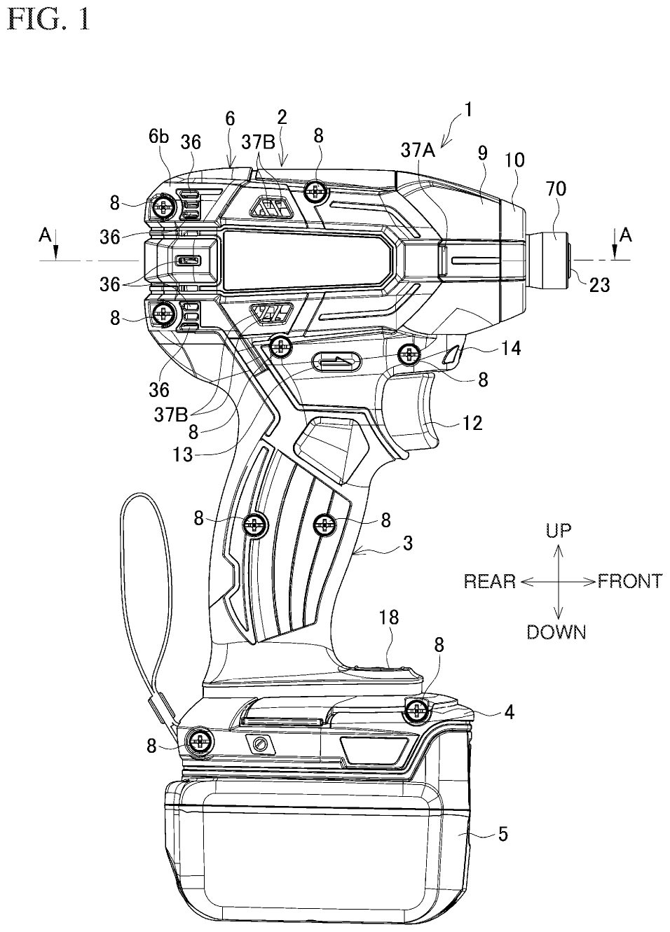

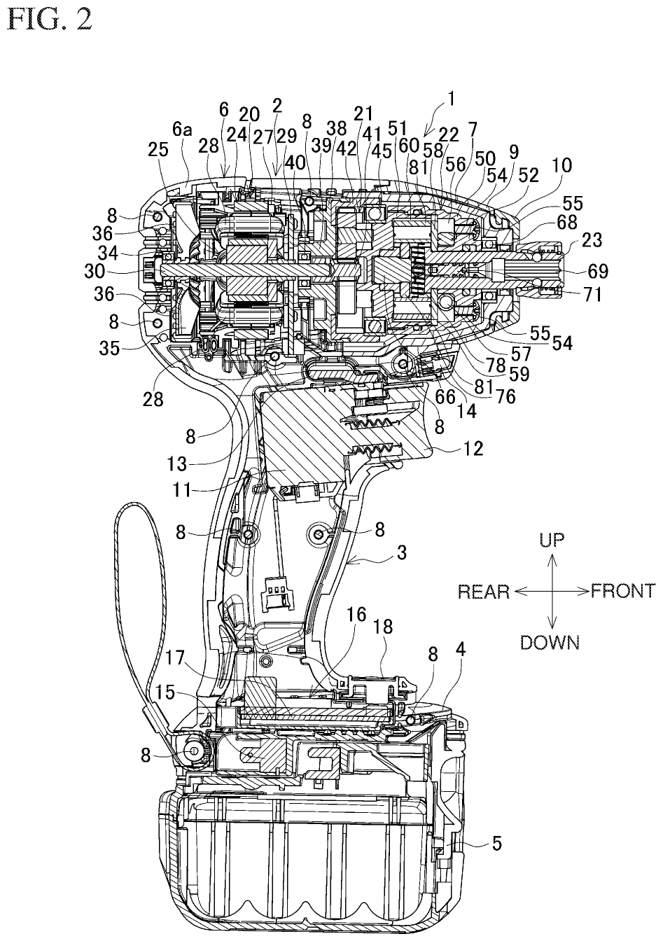

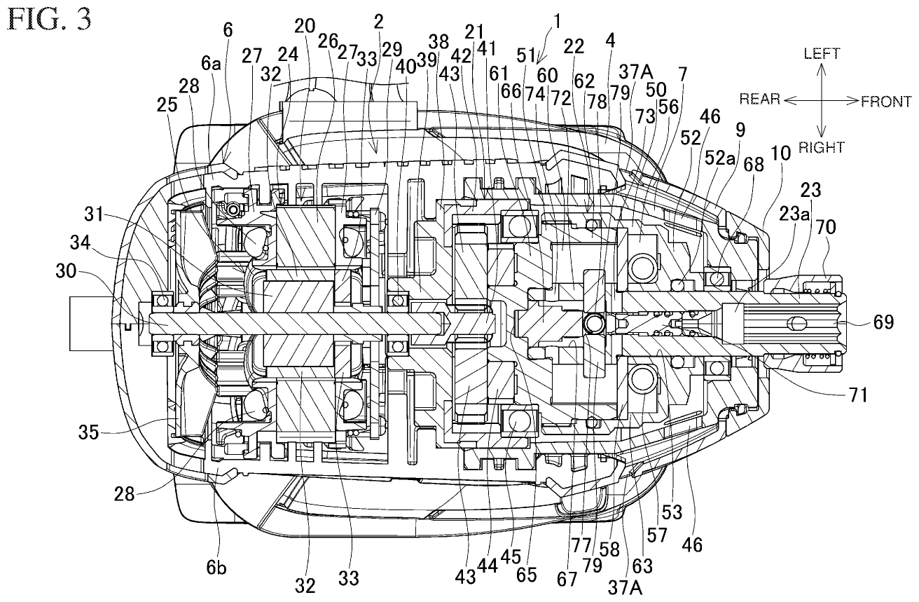

FIG. 1 is a side view of a rechargeable impact driver 1 as an example of a rotary impact tool. FIG. 2 is a longitudinal central sectional view of the impact driver 1. FIG. 3 is an enlarged cross-sectional view taken along line A-A in FIG. 1.

The impact driver 1 includes a body 2 and a grip 3. The body 2 has the central axis extending in the front-rear direction. The body 2 accommodates a brushless motor 20 and an oil unit 22. The grip 3 protrudes downward from the body 2. A battery mount 4 is located at the lower end of the grip 3. The battery mount 4 can receive a battery pack 5 as a power supply attachable from the front.

The impact driver 1 includes a housing including a body housing 6 and a unit case 7. The body housing 6 integrates a rear portion of the body 2, the grip 3, and the battery mount 4 together. The unit case 7 is cylindrically tapered and connected to the front of the body housing 6 to define a front portion of the body 2. The body housing 6 includes a pair of right and left half housings 6a and 6b fastened with screws 8. A resin case cover 9 is externally mounted on the outer surface of the unit case 7. A rubber bumper 10 is externally mounted on the front of the case cover 9.

The grip 3 accommodates a switch 11 in its upper portion. A trigger 12 protrudes frontward from the switch 11. A forward/reverse switch button 13 for switching the rotation of the brushless motor 20 is located above the switch 11. An illumination lamp (LED) 14 for illuminating the front of the body 2 is located above the switch 11. The battery mount 4 supports a terminal block 15. The terminal block 15 is electrically connected to the battery pack 5. A controller 16 is located above the terminal block 15. The controller 16 includes a control circuit board 17. The controller 16 is parallel to the terminal block 15. A switch panel 18 is located above the controller 16. The switch panel 18 includes, for example, an on/off switch for the illumination lamp 14 and an impact force changing button. The switch panel 18 is exposed on the upper surface of the battery mount 4.

The body 2 accommodates, from the rear to the front, the brushless motor 20, a reduction mechanism 21, and the oil unit 22 in the stated order. The oil unit 22 holds a spindle 23. The spindle 23 has a front end protruding frontward from the oil unit 22.

The brushless motor 20 includes a stator 24 and a rotor 25. The brushless motor 20 is an inner-rotor motor including the cylindrical stator 24 and the rotor 25 inside the stator 24. The stator 24 includes a cylindrical stator core 26. The stator core 26 includes multiple steel plates stacked on one another.

The stator 24 includes two insulators 27. The two insulators 27 are fixed to the axial front and rear end faces of the stator core 26. The stator 24 includes multiple (six) coils 28. The coils 28 are wound around the stator core 26 with insulators 27 in between. The front insulator 27 supports a sensor circuit board 29. The sensor circuit board 29 detects the positions of sensor permanent magnets 33 in the rotor 25 and outputs a rotational detection signal. The coils 28 are electrically connected to fuse terminals held on the insulators 27 to form a three-phase connection.

The rotor 25 includes a rotor shaft 30 and a rotor core 31. The rotor shaft 30 extends along the axis of the rotor core 31. The rotor core 31 cylindrically surrounds the rotor shaft 30. The rotor core 31 includes multiple steel plates stacked on one another.

The rotor core 31 receives cylindrical permanent magnet 32. The permanent magnet 32 has four magnetic poles and is arranged outside the rotor core 31. The rotor 25 receives a sensor permanent magnet 33. The sensor permanent magnet 33 has four magnetic poles and is fixed to the rotor core 31. The sensor permanent magnet 33 is located in front of the permanent magnet 32.

The rotor shaft 30 has a rear end held by a bearing 34. The bearing 34 is held on the rear inner surface of the body housing 6. The rotor shaft 30 receives a fan 35 in front of the bearing 34. The body 2 has multiple outlets 36 in its right and left side surfaces outside the fan 35. The body 2 has front inlets 37A in its right and left side surfaces in front of the outlets 36. The front inlets 37A are formed in the right and left rear ends of the case cover 9. Multiple rear inlets 37B are formed behind the front inlets 37A. The rear inlets 37B are located outside a front portion of the brushless motor 20.

The body housing 6 holds a gear case 38 in front of the brushless motor 20. The gear case 38 is disk-shaped and includes a bearing holder 39. The bearing holder 39 supports a bearing 40. The front end of the rotor shaft 30 is supported by the bearing 40. The rotor shaft 30 receives a pinion 41 at its front end. The pinion 41 protrudes frontward through the gear case 38.

The reduction mechanism 21 includes an internal gear 42, multiple (three) planetary gears 43, and a carrier 44. The internal gear 42 is fixed to the front of the gear case 38. The planetary gears 43 mesh with an inner teeth of the internal gear 42. The carrier 44 supports the planetary gears 43. The internal gear 42 has a front end placed in the rear end of the unit case 7. The internal gear 42 supports, at its front end, a rear case 51 of the oil unit 22 via a bearing 45, which is held inside the internal gear 42.

The planetary gears 43 surround and mesh with the pinion 41. The carrier 44 is connected to the rear case 51 of the oil unit 22.

### Oil Unit

The oil unit 22 includes a front case 50, the rear case 51, and the spindle 23.

The front case 50 is cylindrical and located inside the unit case 7, and has the diameter decreasing frontward in a stepwise manner. The front end 52 has a holding hole 53 through which the spindle 23 extends. A seal member 52a is located between the front end 52 and the spindle 23.

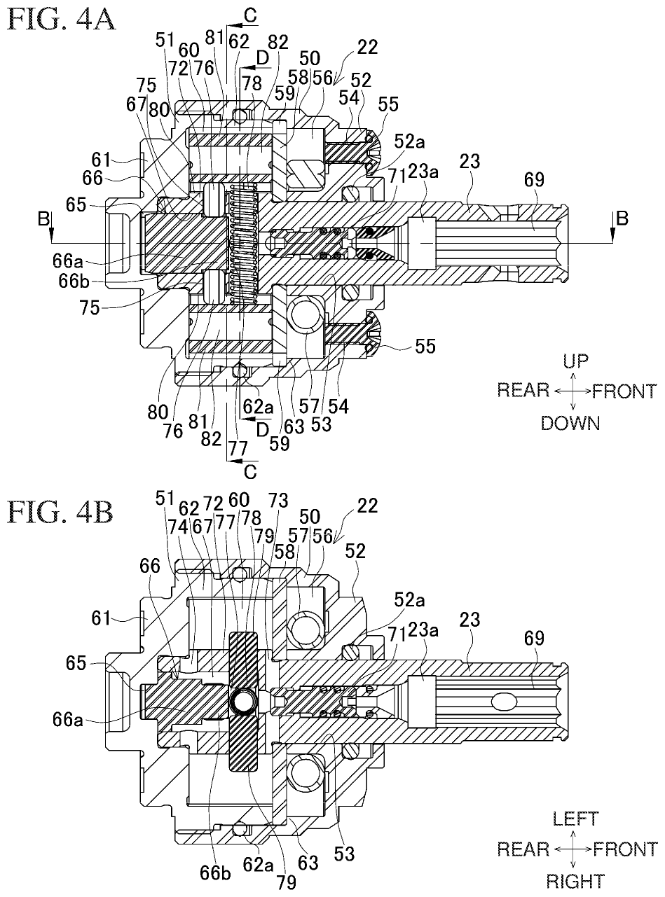

As shown in FIGS. 4A and 4B, a pair of screw holes 54 extend through the front end 52 radially outside the holding hole 53. The screw holes 54 each receive a screw 55 from the front to close the hole. The front end 52 has its inner surface defining an annular front chamber 56. The front chamber 56 communicates with the screw holes 54. The front chamber 56 accommodates a tube 57. The tube 57, which is hollow and encloses air inside, is received in the front chamber 56 annularly. A partition 58 is located behind the tube 57. The partition 58 has multiple cutouts 59 on its outer periphery. A rear chamber 60 is located behind the partition 58. The front chamber 56 and the rear chamber 60 communicate with each other thorough the cutouts 59.

The rear case 51 has a central portion 61 and a side wall 62. The central portion 61 is a disk shaped and supports the bearing 45. The side wall 62 is cylindrical and protrudes frontward from the outer periphery of the central portion 61. The side wall 62 is screwed into the front case 50 from the rear and connected to the front case 50. A seal member 62a is located between the side wall 62 and the front case 50.

The side wall 62 is in contact with the partition 58 at its front end. The front case 50 has a step 63 on its inner surface. The partition 58 is fixed between the side wall 62 and the step 63.

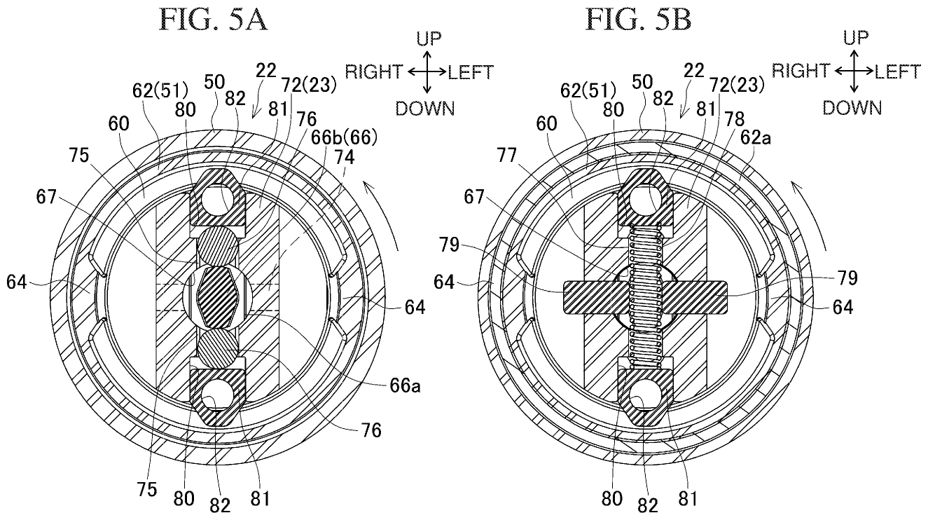

As shown in FIGS. 5A and 5B, the side wall 62 has a pair of projections 64 on its inner peripheral surface. The projections 64 are point-symmetric to each other about the axis of the rear case 51 and are raised inward. The projections 64 each have a sloped cross section with a circumferential width decreasing radially inward.

The central portion 61 has a recess 65 at its center. The recess 65 is stepped to have a center portion deeper than an outer portion. The recess 65 receives a cam 66 facing frontward in the center portion. The cam 66 has, at the rear, a flat portion 66a with a width across flats. The cam 66 has, at the front, a thinner portion 66b with a thickness gradually decreasing radially outward from the thickest center. The flat portion 66a and the thinner portion 66b are orthogonal to a straight line connecting the centers of the projections 64 as viewed from the front.

The spindle 23 has a through-hole 23a along the axis. The through-hole 23a defines, in its rear portion, a pressurized enclosure 67 in the rear chamber 60. The pressurized enclosure 67 has a circular cross section and receives the cam 66 in a relatively rotatable manner. The spindle 23 has a rear end located outside the cam 66 and supported in the recess 65 on the rear case 51. The spindle 23 has a middle portion supported by the unit case 7 via a bearing 68. The through-hole 23a has a front portion serving as a receiving hole 69 for receiving a tip tool, such as a screwdriver bit. A sleeve 70 for attaching and detaching a tip tool surrounds the receiving hole 69. An output adjustment plug 71 closes the rear portion of the receiving hole 69. The output adjustment plug 71 is screwed into the through-hole 23a.

The front case 50, the rear case 51, the screws 55, the spindle 23, and the output adjustment plug 71 define a sealed space including the front chamber 56 and the rear chamber 60. The sealed space contains oil. The oil is supplied through the screw holes 54. The oil pressure can be changed with the output adjustment plug 71. The output adjustment plug 71 is rotated to adjust the position using a tool, such as a screwdriver, placed in the through-hole 23a from the front.

As shown in FIGS. 5A and 5B, the spindle 23 has a rear portion 72 having an elongated cross section extending across the diameter of the rear case 51. However, the longitudinal dimension of the rear portion 72 is shorter than the distance between the projections 64 facing each other on the rear case 51. The rear portion 72 is located between the partition 58 and the central portion 61 of the rear case 51. The rear portion 72 has, on its front and rear surfaces, a front communication hole 73 and a rear communication hole 74 each extending radially through the spindle 23. The front communication hole 73 allows communication between the through-hole 23a and the rear chamber 60 when the rear portion 72 is in contact with the partition 58. The rear communication hole 74 allows communication between the through-hole 23a and the rear chamber 60 when the rear portion 72 is in contact with the central portion 61.

The rear portion 72 has a pair of rear holes 75 outside the cam 66. The rear holes 75 communicate with the through-hole 23a and extend radially through the spindle 23. The rear holes 75 each receive a pin 76. Each pin 76 is circular as viewed from the front and has a front flat surface and a rear flat surface. Each pin 76 is radially movable in the rear hole 75. The pin 76 moving inward can come in contact with the thinner portion 66b of the cam 66.

A front hole 77 extends in front of and parallel to the rear hole 75 through the rear portion 72. The front hole 77 accommodates a coil spring 78. A pair of stopper pins 79, which are orthogonal to the coil spring 78, are fitted in the rear portion 72. The stopper pins 79 each have an end located adjacent to the outer surface of the coil spring 78 to prevent buckling of the coil spring 78.

A pair of holding grooves 80 are located on the longitudinal ends of the rear portion 72. The holding grooves 80 allows communication between the rear holes 75 and the front hole 77. The holding grooves 80 each extend in the front-rear direction and are open along the longitudinal ends of the rear portion 72.

Each holding groove 80 receives a blade 81. Each blade 81 has a width substantially within the circumferential width of the holding groove 80 and a length substantially within the entire length of the holding groove 80 in the front-rear direction. The blade 81 is held in the holding groove 80 in a manner movable in the radial direction of the spindle 23. The blade 81 moving inward can come in contact with the pin 76. The blade 81 has its radially inner end face in contact with an end of the coil spring 78 in front of the pin 76. The blade 81 has its radially outer end with a width decreasing radially outward to slope. The blade 81 has a through-hole 82 in the front-rear direction.

When the thinner portion 66b of the cam 66 is parallel to the longer sides of the rear portion 72 in the cross section in the pressurized enclosure 67 in the rear portion 72, the cam 66 pushes the pins 76 radially outward. The pins 76 also push the blades 81 radially outward. In this state, the blades 81 approach the inner peripheral surface of the rear case 51 without coming in contact with the inner peripheral surface. At this position, the blades 81 may hit the projections 64 in the circumferential direction. However, the blades 81 are urged to be apart from the pins 76 until coming in contact with the inner peripheral surface of the rear case 51 by the coil spring 78 compressed between the blades 81 in front of the pins 76.

The operation of the impact driver 1 according to the first embodiment will be described.

A user holding the grip 3 pulls the trigger 12. The switch 11 is turned on to cause the battery pack 5 to supply a three-phase current to the stator 24 in the brushless motor 20, thus rotating the rotor 25. More specifically, the microcomputer in the control circuit board 17 receives, from a rotation detection element in the sensor circuit board 29, a rotation detection signal indicating the positions of the sensor permanent magnets 33 in the rotor 25, and determines the rotational state of the rotor 25. The microcomputer then controls the on-off state of each switching element in accordance with the determined rotational state, and feeds a three-phase current sequentially through the coils 28 in the stator 24. This rotates the rotor shaft 30 together with the rotor 25.

The rotation of the rotor shaft 30 is transmitted to the planetary gears 43 via the pinion 41. The planetary gears 43 revolving in the internal gear 42 reduce the rotation to be transmitted to the rear case 51 of the oil unit 22 through the carrier 44. The rear case 51 thus rotates together with the front case 50.

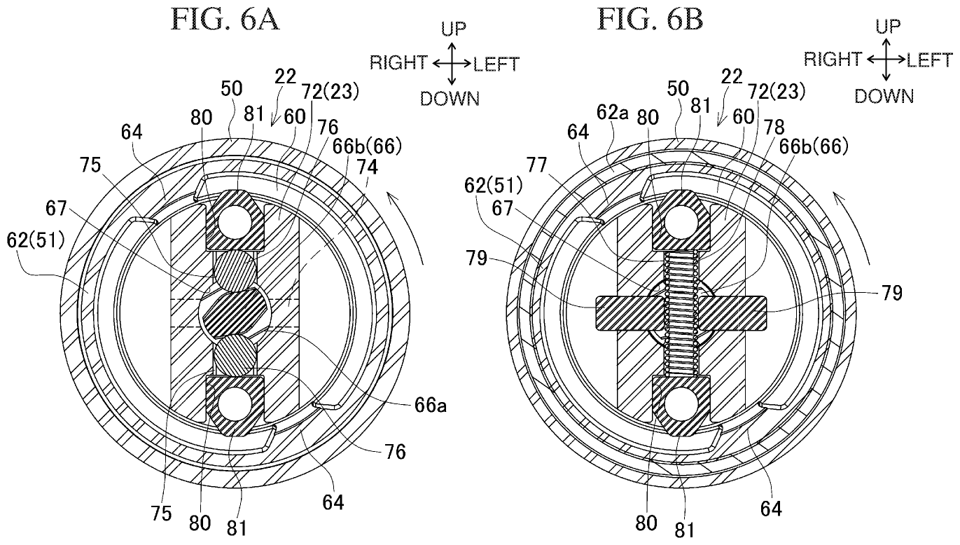

As shown in FIGS. 6A and 6B, the cam 66 rotates in the direction indicated by an arrow together with the rear case 51 in the oil unit 22. The thinner portion 66b of the cam 66 then pushes the blades 81 out of the rear portion 72 via the pins 76. The urging force from the coil spring 78 also contributes to pushing out the blades 81. When the cam 66 rotates further to allow communication between the rear communication hole 74 and the pressurized enclosure 67, oil flows into the pressurized enclosure 67. The oil flowing through the rear holes 75 and the front hole 77 to the holding grooves 80 facilitates the operation of pushing out the pins 76 and the blades 81.

When the cam 66 rotates still further together with the rear case 51 to have the thinner portion 66b parallel to the rear portion 72, the cam 66 pushes the pins 76 and the blades 81 most outwardly as shown in FIGS. 5A and 5B. With the cam 66 pushing the blades 81, the distal end of each blade 81 does not come in contact with the inner peripheral surface of the rear case 51.

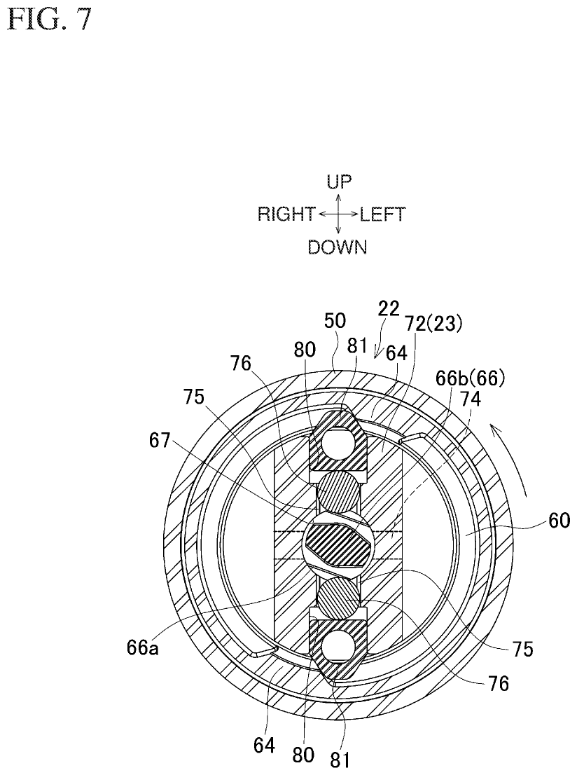

The urging force from the coil spring 78 also contributes to pushing out the blades 81. However, when the oil unit 22 is at a lower temperature and the oil has higher viscosity, the moving speed of the blades 81 decreases even under the urging force from the coil spring 78. When the rear case 51 and the cam 66 rotate still further, the blades 81 come in contact with the projections 64 before reaching the inner peripheral surface of the rear case 51 as shown in FIG. 7.

At this rotational position, the cam 66 prevents communication between the rear communication hole 74 and the pressurized enclosure 67, increasing the oil pressure inside the pressurized enclosure 67. This retains the blades 81 that have been pushed out. The blades 81 hitting the projections 64 produce an impact torque (impact). The impact torque transmits to the spindle 23 from the blade.

With the oil having higher viscosity at lower temperatures, the blades 81 retracting from the projections 64 receive a larger resistance when the impact is produced. The urging force from the coil spring 78 also applies a resistance against retracting, thus producing a higher impact torque.

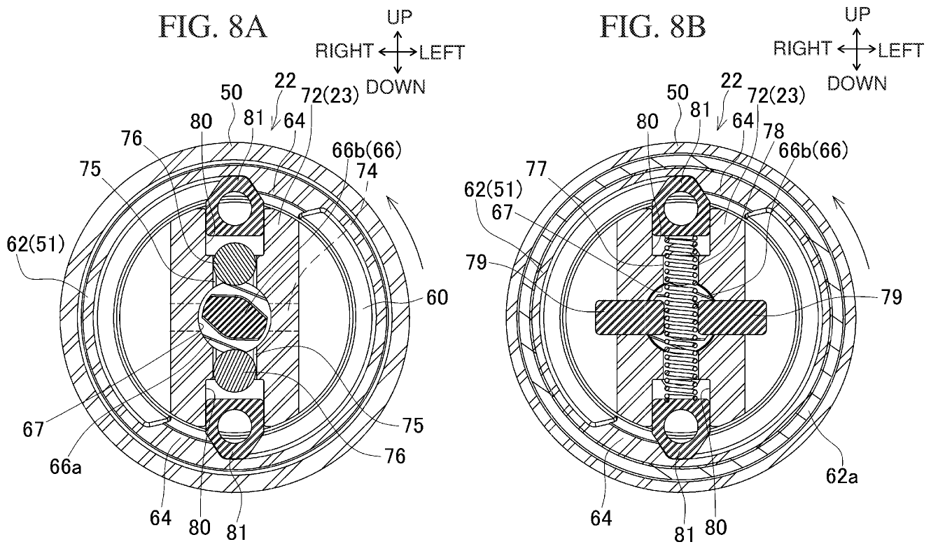

When the oil unit 22 is at a higher temperature and the oil has lower viscosity, the blades 81 move away from the pins 76 and reach the inner peripheral surface of the rear case 51 under the urging force from the coil spring 78 before hitting the projections 64 as shown in FIGS. 8A and 8B. The blades 81 that have been pushed out hit the projections 64 there to produce an impact torque.

With the oil having lower viscosity, the blades 81 retracting from the projections 64 receive a smaller resistance when the impact is produced. However, the blades 81 retract in a larger stroke from the inner peripheral surface of the rear case 51 after reaching the inner peripheral surface. The urging force from the coil spring 78 also applies a resistance against retracting. This reduces the decrease in the impact torque.

When the oil expands in volume at a higher temperature, the tube 57 in the front chamber 56 contracts due to the expanded oil. This reduces the internal pressure increase caused by the high temperature oil.

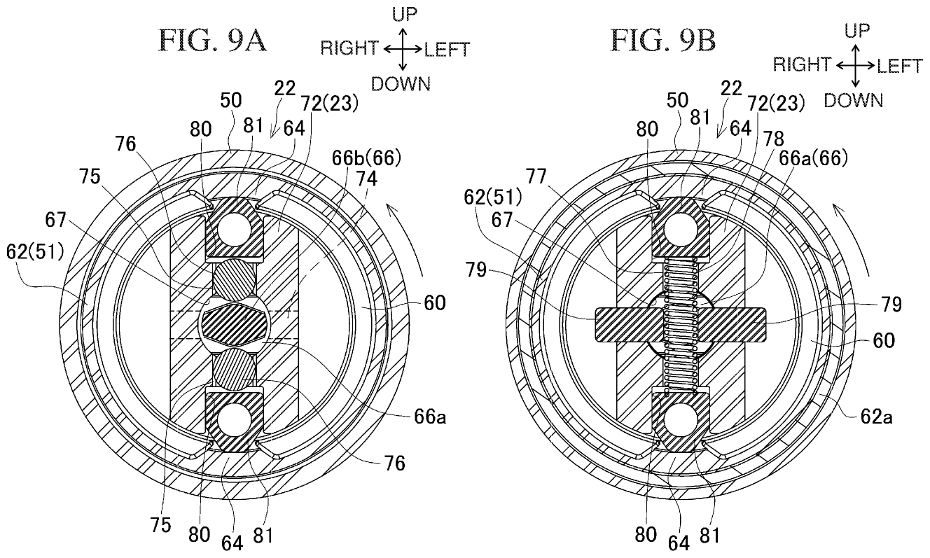

After the impact torque is produced, each blade 81 retracts inward with the slope guided along a slope on the corresponding projection 64. The oil in the pressurized enclosure 67 flows into the rear chamber 60 through the clearance between the components, thus allowing the blades 81 to retract. As shown in FIGS. 9A and 9B, the retracted blades 81 move relatively over the projections 64.

Referring back to FIGS. 6A and 6B, the cam 66 rotating together with the rear case 51 starts pushing out the blades 81.

The repeated operation produces the impact torque twice per rotation of the rear case 51.

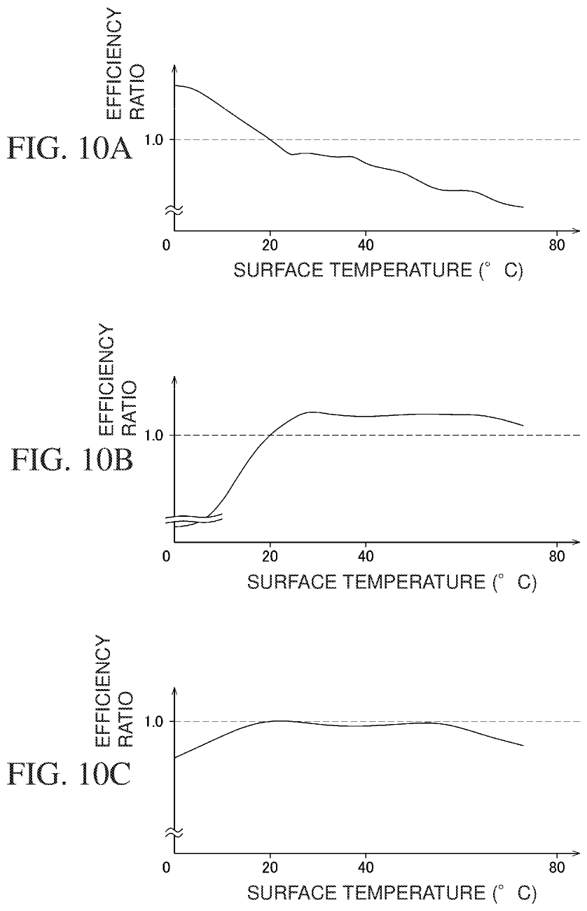

FIGS. 10A to 10C are graphs each showing the relationship between the surface temperature of an oil unit and the efficiency ratio. The efficiency ratio is the ratio of the torque at the surface temperature of 20° C. defined as 1.0 to the torque at each temperature. FIG. 10A shows a known pushing structure of the blades simply using a cam and balls. FIG. 10B shows a pushing structure of the blades simply using a coil spring without the cam and the balls. FIG. 10C shows a pushing structure of the blades using the cam, the pins, and the coil spring according to the first embodiment.

For the structure simply including the cam and the balls in FIG. 10A, the efficiency ratios are high at lower temperatures. However, the efficiency ratio gradually decreases from 1.0 as the temperature increases and the torque decreases.

For the structure simply including the coil spring in FIG. 10B, the efficiency ratios are low at lower temperatures. However, the torque increases as the temperature increases until the efficiency ratio exceeds 1.0, and then the efficiency ratio remains 1.0 or more with less fluctuations.

For the structure according to the first embodiment in FIG. 10C, the efficiency ratios at lower temperatures are slightly below 1.0, but are relatively high values. The torque increases as the temperature increases, and then stabilizes near substantially 1.0.

As described above, the pushing structure according to the first embodiment provides the features achievable by the cam and the pins at lower temperatures, and provides the features achievable by the coil spring at higher temperatures. The structure thus provides stable efficiency ratios across the entire (lower to higher) temperature region.

The fan 35 rotates as the rotor shaft 30 rotates, thus forming an airflow from the front inlets 37A and the rear inlets 37B toward the outlets 36. The airflow cools the internal components, such as the brushless motor 20 and the oil unit 22. More specifically, air flowing through the front inlets 37A passes through a clearance between the unit case 7 and the case cover 9 and through ventilation holes 46 (FIG. 3) in the unit case 7 and enters the unit case 7. The air then flows between the unit case 7 and the oil unit 22. The air flows between the internal gear 42 and the unit case 7 to the brushless motor 20. The air merges with air flowing through the rear inlets 37B to cool the brushless motor 20, and is then discharged through the outlets 36.

The impact driver 1 according to the first embodiment includes the brushless motor (motor) 20 and the oil unit 22 rotatable by the brushless motor 20. The oil unit 22 includes the front case 50 and the rear case 51 (case), and the spindle 23 (output shaft) protruding from the cases. The rear case 51 includes the projections 64. The rear case 51 accommodates the coil spring 78 (elastic member) held at the spindle 23. The oil unit 22 includes the blades 81 (torque transmission members) held at the spindle 23 in the rear case 51 and urged outward in the radial direction of the rear case 51 by the coil spring 78. The blades 81 come in contact with the projections 64 in the rotation direction of the rear case 51.

When the oil unit 22 is at a lower temperature and the oil has higher viscosity, the cam 66 and the pins 76 allow the blades 81 to move in intended strokes. In other words, an intended torque can be produced. In contrast, when the oil unit 22 is at a higher temperature and the oil has lower viscosity, the blades 81 retracting after hitting the projections 64 receive a higher resistance under the urging force from the coil spring 78. This reduces the torque decrease. The torque produced in the oil unit 22 is thus leveled irrespective of the temperature variation, thus maintaining intended operation efficiency.

The rear case 51 accommodates the cam 66 that pushes the blades 81 outward in the radial direction of the rear case 51 via the pins 76 (pushing members) as the rear case 51 rotates. The pins 76 are located either frontward or rearward from the coil spring 78 in the axial direction of the spindle 23. The single coil spring 78 can thus urge the two blades 81 without interfering with the pins 76.

The coil spring 78 is used as an elastic member to reliably push out the blades 81. The coil spring 78 is deformable and thus allows easy assembly.

In the first embodiment, the pins are located rearward and the coil spring is located frontward. In some embodiments, the pins may be located frontward and the coil spring may be located rearward reversely. Multiple coil springs may be located, for example, in front of and behind the pins. The stopper pins may be eliminated.

In the first embodiment, the single coil spring extends through the spindle to urge the pair of blades outward. In some embodiments, a pair of shorter coil springs may each be located between the bottom of the holding groove and the blade.

The pushing members are not limited to the pins, but may be balls. Such multiple pushing members may overlap one another in the radial direction.

However, the coil spring may be simply located between the blades or between the bottom of the holding groove and the blade to apply an urging force from the coil spring alone, without the cam and the pushing members, to push the blades radially outward.

### Second Embodiment

A second embodiment will now be described. The overall structure of the impact driver 1 excluding an oil unit is the same as in the first embodiment. The oil unit has a different structure, so hereafter it is described mainly.

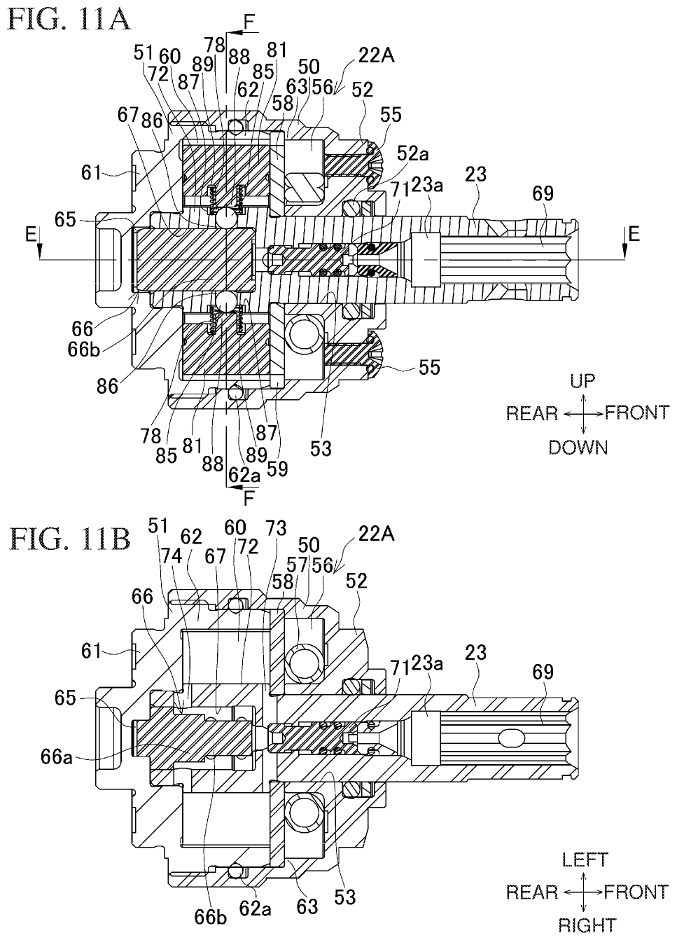

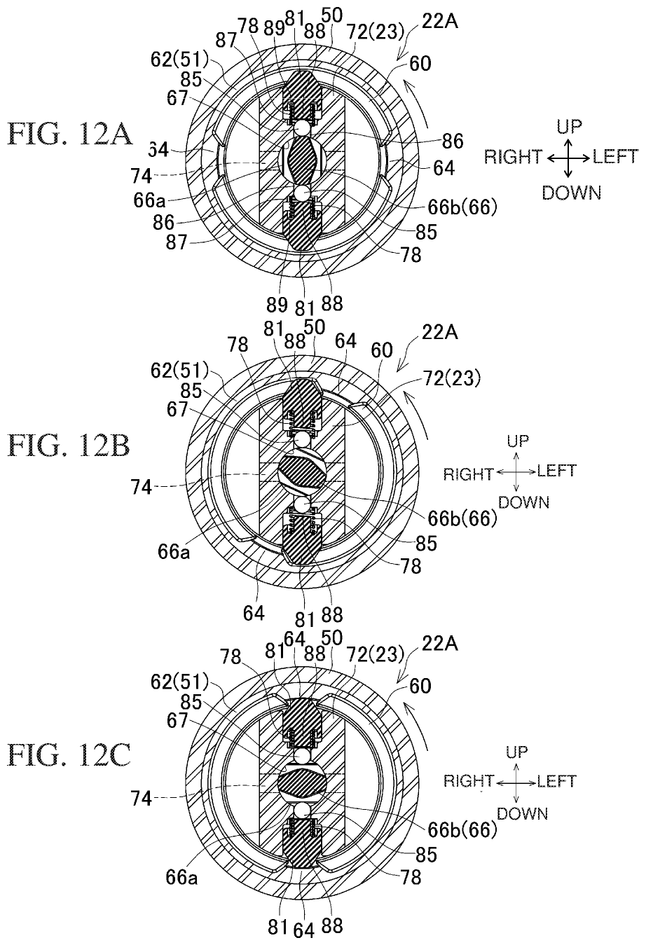

An oil unit 22A shown in FIGS. 11A to 12A includes balls 85 as pushing members. The balls 85 are located at the same positions as the coil springs 78 in the axial direction of the spindle 23.

The balls 85 are received in holes 86 formed in the rear portion 72 radially outside the thinner portion 66b of the cam 66. The holes 86 each have an opening end with a larger-diameter portion 87 at the bottom of the corresponding holding groove 80.

Each blade 81 includes a boss 88 protruding inward from its radially internal end face. The axial line of the boss 88 aligns with a line passing through the center of the ball 85 in the radial direction of the spindle 23. In other words, the ball 85 and the boss 88 are aligned with each other in the radial direction of the spindle 23. An annular groove 89 is located at a position corresponding to the basal end of the boss 88 at the end face of the blade 81. The coil spring 78 is externally mounted on the boss 88, and one end of the coil spring 78 is fitted in the groove 89. The other end of the coil spring 78 comes in contact with the larger-diameter portion 87 at the bottom of the holding groove 80. The blades 81 are thus pushed radially outward when the balls 85 come in contact with the bosses 88. The blades 81 are also urged radially outward by the coil springs 78 each located between the spindle 23 and the corresponding blade 81.

The cam 66 rotates together with the rear case 51 in the second embodiment. The thinner portion 66b then pushes the blades 81 out of the rear portion 72 via the balls 85 in the same manner as in the first embodiment. The urging force from the coil springs 78 also contributes to pushing out the blades 81. When the cam 66 rotates further to allow communication between the rear communication hole 74 and the pressurized enclosure 67, oil flows into the pressurized enclosure 67. The oil flows through the holes 86 to the holding grooves 80, facilitating the operation of pushing out the balls 85 and the blades 81.

When the cam 66 rotates still further together with the rear case 51 to be parallel to the rear portion 72, the cam 66 pushes the balls 85 and the blades 81 most outwardly as shown in FIG. 12A.

At the positions of the blades 81 pushed out as shown in FIG. 12A, the distal end of each blade 81 does not come in contact with the inner peripheral surface of the rear case 51. However, at higher temperatures, the coil springs 78 push the blades 81 further outward, apart from the balls 85.

When the rear case 51 and the cam 66 rotate together further to cause the blades 81 to hit the projections 64, the cam 66 prevents communication between the rear communication hole 74 and the pressurized enclosure 67 as shown in FIG. 12B. The oil pressure in the pressurized enclosure 67 increases to retain the blades 81 that have been pushed out. The blades 81 hitting the projections 64 thus produce an impact torque (impact). The impact torque transmits to the spindle 23 from the blade. With the oil having lower viscosity when the impact is produced, the blades 81 retract in a larger stroke from the inner peripheral surface of the rear case 51 after reaching the inner peripheral surface. The urging force from the coil springs 78 also applies a resistance against retracting. This reduces the impact torque decrease.

After the impact torque is produced, each blade 81 retracts inward with the slope guided along a slope on the corresponding projection 64. As shown in FIG. 12C, the retracted blades 81 move relatively over the projections 64.

After the blades 81 move over the projections 64, the rear communication hole 74 and the pressurized enclosure 67 communicate with each other as the rear case 51 and the cam 66 rotate. The cam 66 pushes the blades 81 via the balls 85 again.

In the second embodiment as well, when the oil unit 22A is at a lower temperature and the oil has higher viscosity, the cam 66 and the balls 85 allow the blades 81 to move in intended strokes. In other words, an intended torque can be produced. In contrast, when the oil unit 22A is at a higher temperature and the oil has lower viscosity, the blades 81 receive a higher resistance when retracting after hitting the projections 64 under the urging force from the coil springs 78. This reduces the torque decrease. The torque produced in the oil unit 22A is thus leveled irrespective of the temperature variation, thus maintaining intended operation efficiency.

The balls 85 as the pushing members are located at the same positions as the coil springs 78 in the axial direction of the spindle 23. So the oil unit 22A including the coil springs 78 can be axially compact.

In the second embodiment, the larger-diameter portion of the hole or the groove on the boss may be eliminated when the coil spring can be positioned appropriately. Multiple coil springs may be located, for example, in front of and behind the boss.

The pushing members other than the balls may be used, or multiple different types of pushing members may be used.

The number of torque transmission members such as the blades and the number of pushing members are each not limited to a pair of members in the above embodiments. A single set of such members or three or more sets of such members may be used in the embodiments. The elastic member is not limited to the coil spring.

Two pushing members, or a first pushing member and a second pushing member, are used to move a single torque transmission member radially outward in the embodiments of the present invention. The first pushing member is not limited to a pin or a ball, and the second pushing member is not limited to a coil spring as in the above embodiments. For example, both the first pushing member and the second pushing member may be elastic members such as coil springs. In some embodiments, both the first pushing member and the second pushing member may be rigid members such as pins or balls.

The oil unit may not be divided into the front and rear cases, but may be divided into right and left cases. The oil unit may include three or more parts. The partition may be eliminated not to separate the front chamber and the rear chamber. The tube may be eliminated.

The rotary impact tool is not limited to the impact driver including the spindle serving as the output shaft in the oil unit. For example, the rotary impact tool may be an angle tool including a final output shaft orthogonally fitted on the front of the spindle.

The motor is not limited to a brushless motor, but may be a commutator motor. The present invention is also applicable to a tool powered by an alternating current (AC) without including a battery pack.

### REFERENCE SIGNS LIST

1 impact driver
2 body
3 grip
6 body housing
7 unit case
16 controller
17 control circuit board
20 brushless motor
21 reduction mechanism
22, 22A oil unit
23 spindle
30 rotor shaft
50 front case
51 rear case
56 front chamber
58 partition
60 rear chamber
64 projection
66 cam
67 pressurized enclosure
72 rear portion
75 rear hole
76 pin
77 front hole
78 coil spring
80 holding groove
81 blade
85 ball
88 boss

What is claimed is:

1. A rotary impact tool, comprising:
a motor; and
an oil unit configured to rotate by the motor, the oil unit including
a case including a projection inside,
an output shaft protruding from the case,
an elastic member held at the output shaft in the case, and
a torque transmission member held at the output shaft in the case and urged outward in a radial direction of the case by the elastic member, the torque transmission member being configured to come in contact with the projection in a rotation direction of the case.

2. The rotary impact tool according to claim 1, wherein
the oil unit includes
a pushing member located frontward or rearward from the elastic member in an axial direction of the output shaft, and
a cam configured to push the torque transmission member outward in the radial direction of the case via the pushing member as the case rotates.

3. The rotary impact tool according to claim 2, wherein
the oil unit includes a pressurized enclosure including the cam in a relatively rotatable manner and configured to receive oil,
the output shaft has a communication hole to communicate with the pressurized enclosure,
the cam has a thinner portion with a thickness gradually decreasing radially outward from a thickest center, and
the thinner portion pushes out the torque transmission member via the pushing member to allow communication between the pressurized enclosure and the communication hole.

4. The rotary impact tool according to claim 1, wherein
the torque transmission member comes in contact with the projection before reaching an inner peripheral surface of the case.

5. The rotary impact tool according to claim 1, wherein
the oil unit includes
a pushing member located at the same position as the elastic member in an axial direction of the output shaft, and
a cam configured to push the torque transmission member outward in the radial direction of the case via the pushing member as the case rotates.

6. The rotary impact tool according to claim 1, wherein
the elastic member is a coil spring.

7. The rotary impact tool according to claim 2, wherein
the elastic member is more easily deformable than the pushing member.

8. The rotary impact tool according to claim 2, wherein
the torque transmission member comes in contact with the projection before reaching an inner peripheral surface of the case.

9. The rotary impact tool according to claim 3, wherein
the torque transmission member comes in contact with the projection before reaching an inner peripheral surface of the case.

10. The rotary impact tool according to claim 2, wherein
the elastic member is a coil spring.

11. The rotary impact tool according to claim 3, wherein
the elastic member is a coil spring.

12. The rotary impact tool according to claim 4, wherein
the elastic member is a coil spring.

13. The rotary impact tool according to claim 5, wherein
the elastic member is a coil spring.

14. The rotary impact tool according to claim 3, wherein
the elastic member is more easily deformable than the pushing member.

15. The rotary impact tool according to claim 4, wherein
the elastic member is more easily deformable than the pushing member.

16. The rotary impact tool according to claim 5, wherein
the elastic member is more easily deformable than the pushing member.

17. The rotary impact tool according to claim 6, wherein
the elastic member is more easily deformable than the pushing member.

18. A rotary impact tool, comprising:
a motor; and
an oil unit configured to rotate by the motor, the oil unit including
a case including a projection inside,
an output shaft protruding from the case,
at least one torque transmission member held at the output shaft in the case,
a first pushing member held at the output shaft in the case and configured to move the torque transmission member outward in a radial direction of the case as the case rotates, and
a second pushing member held at the output shaft in the case and configured to move the torque transmission member moved by the first pushing member outward in the radial direction of the case as the case rotates.
